(19) United States
(12) Patent Application Publication
(10) Pub. No.: US 2010/0225664 A1
(43) Pub. Date: Sep. 9, 2010

(54) CONTENT DISPLAY APPARATUS

(75) Inventor: Kenji Ogasawara, Kawaguchi-shi (JP)

Correspondence Address: SIDLEY AUSTIN LLP, 717 NORTH HARWOOD, SUITE 3400, DALLAS, TX, 75201, US

(73) Assignee: Konica Minolta Business Technologies, Inc., Tokyo (JP)

(21) Appl. No.: 12/713,492

(22) Filed: Feb. 26, 2010

(30) Foreign Application Priority Data
Mar. 4, 2009 (JP) 2009-050262

(51) Int. Cl. G09G 5/32

(52) U.S. Cl. 345/619; 345/660

(57) ABSTRACT

A movable content display apparatus with a display section displaying contents including; a position detecting section which is arranged on the surface on the opposite side of the display section and detecting image patterns; and a control section shifting a display position of the image of the contents being displayed in the display section by a distance according to the movement distance and in a direction opposite to the movement direction, when the position detecting section detects from the changes in the image pattern that the own apparatus has moved on a table by a certain movement distance in a certain movement direction.

### RELATED APPLICATION

The present application is based on Patent Application No. 2009-050262 filed at the Japan Patent Office on Mar. 4, 2009 and which is hereby incorporated herein in its entirety.

### TECHNICAL FIELD

The present invention relates to content display apparatuses provided with the function of displaying contents, and in particular, to movable thin type content display apparatuses.

### BACKGROUND

In recent years, thin type display apparatuses such as electronic papers or electronic books, etc., have been developed and the number of users reading contents such as documents, books, etc., using such display apparatuses is increasing. In such display apparatuses (hereinafter referred to as content display apparatuses), when displaying images of contents having a larger area than the display area, methods have been used for displaying the desired area by reducing the size of the image, or by moving the image of the contents to the left, right, up, or down by operating a particular button, etc.

Regarding the above technology of displaying images of contents, for example, in the Unexamined Japanese Patent Application Publication No. 2003-169351, a method of displaying images stereoscopically has been disclosed that has, a step of displaying in a display apparatus a first image that has to be viewed stereoscopically and storing in memory the appropriate position for stereoscopic viewing that was judged by adjusting that display position, a step of reading out said appropriate position at the time of displaying in said display apparatus a second image that has to be viewed stereoscopically, and a step of displaying said second image that has to be viewed stereoscopically while placing it so that said appropriate position that has been read out is satisfied.

Further, in the Unexamined Japanese Patent Application Publication No. 2007-219606, an information processing system has been disclosed which is an information processing system that writes to and displays images in a display medium having a display section that retains the display of images in the no power supply condition, and which system is provided with a writing section that writes in the display medium a partial image that is obtained by segmenting the document image, and a display section that displays the position of that partial image with respect to that document image every time a partial image of the document image is written in the display medium.

Further, as a technology of establishing correspondence between content display apparatuses and other display devices, in the Unexamined Japanese Patent Application Publication No. 2005-31448, an information processing system has been disclosed which has a display section, a detecting section that detects the position and state of a media having an image display function, and a control section that establishes correspondence between said display section and said medium according to the result of detection by said detecting section.

Further, in the Unexamined Japanese Patent Application Publication No. 2006-31373, a displaying and recording medium has been disclosed which is a portable displaying and recording medium having a display section that retains the display of document images, and which is provided with an identification data retaining section that retains the identification data identifying the document which is displayed and retained in said displaying and retaining section, a detecting section that detects other adjacent displaying and recording media, an acquisition section that acquires said identification data from the other adjacent displaying and recording media, and a management section that manages said acquired identification data while establishing correspondence with the position relationship with said detected other adjacent displaying and recording media, and which displaying and recording medium has the function of managing the position relationship between the document displayed and retained by itself with the documents displayed and retained by the adjacent displaying and recording media.

### SUMMARY

One aspects of the present invention is a movable content display apparatus with a display section displaying contents including; a position detecting section which is arranged on the surface on the opposite side of the display section and detecting image patterns; and a control section shifting a display position of the image of the contents being displayed in the display section by a distance according to the movement distance and in a direction opposite to the movement direction, when the position detecting section detects from the changes in the image pattern that the own apparatus has moved on a table by a certain movement distance in a certain movement direction.

Another aspect of the present invention is a plurality of movable content display apparatuses with display sections displaying contents and a communication sections wherein each of the content display apparatuses including; a plurality of image patterns storing own apparatus position information and apparatus information identifying own apparatus wherein the image patterns are on the peripheral edge parts on the same surface of the display section; at least one position detecting section arranged on the surface on the opposite side of the display section and detecting image patterns; a control section of the second content display apparatus detecting the relative position of the own apparatus relative to the first content display apparatus based on the position of the first image pattern of the first content display apparatus and the position of the position detecting section of the second content display apparatus, obtaining the contents and display position of the image being displayed in the display section of the first content display apparatus identified by the apparatus information stored in the first image pattern by using the communication section, shifting the display position of the image of the contents based on the relative position, and displaying in the display section of own apparatus, when the position detecting section detects a first image pattern of the first content display apparatus, in case of a second content display apparatus is laid over a first content display apparatus.

### BRIEF DESCRIPTION OF THE DRAWINGS

FIG. 1 is a block diagram showing the configuration of a content display apparatus according to a preferred embodiment of the present invention.

FIG. 2a is a diagram showing an example of the configuration of the front surfaces and the configuration of operation buttons of a content display apparatus according to a preferred embodiment of the present invention.

FIG. 2b is a diagram showing an example of the configuration of the back surfaces and the configuration of operation buttons of a content display apparatus according to a preferred embodiment of the present invention.

FIG. 2c is a diagram showing an example of the configuration of the configuration of operation buttons of a content display apparatus according to a preferred embodiment of the present invention.

FIG. 3 is a diagram showing an example of the configuration of a position information posting section (bar code) placed in the peripheral edge part of the surface of a content display apparatus according to a preferred embodiment of the present invention.

FIG. 4 is a diagram showing an example of the configuration of a display section of a content display apparatus according to a preferred embodiment of the present invention.

FIG. 5 is a diagram showing an example of an image of a content (display without magnification).

FIG. 6 is a diagram showing an example of an image of a content (display with ½ reduction).

FIG. 7 is a diagram showing an example of the display in two content display apparatuses according to a preferred embodiment of the present invention.

FIG. 8 is a diagram showing another example of the display in two content display apparatuses according to a preferred embodiment of the present invention.

FIG. 9 is a diagram showing the method of estimating the initial setting condition in two content display apparatuses according to a preferred embodiment of the present invention.

FIG. 10 is a diagram showing the region of display in two content display apparatuses according to a preferred embodiment of the present invention.

FIG. 11 is a diagram showing another example of the display in two content display apparatuses according to a preferred embodiment of the present invention.

FIG. 12 is a diagram showing the method of adjusting the display position in a content display apparatus according to a preferred embodiment of the present invention.

FIG. 13 is a diagram showing the method of adjusting the magnification in a content display apparatus according to a preferred embodiment of the present invention.

FIG. 14 is a diagram showing the method of changing the contents in a content display apparatus according to a preferred embodiment of the present invention.

FIG. 15 is a flow chart showing the procedure of displaying contents using a content display apparatus according to a preferred embodiment of the present invention.

FIG. 16 is a flow chart showing the procedure of displaying contents using a content display apparatus according to a preferred embodiment of the present invention.

FIG. 17 is a flow chart showing the procedure (special pattern processing) of displaying contents using a content display apparatus according to a preferred embodiment of the present invention.

FIG. 18 is a flow chart showing the procedure (initial setting position estimation processing) of displaying contents using a content display apparatus according to a preferred embodiment of the present invention.

FIG. 19 is a flow chart showing the procedure (display size changing processing) of displaying contents using a content display apparatus according to a preferred embodiment of the present invention.

FIG. 20 is a flow chart showing the procedure (display contents changing processing) of displaying contents using a content display apparatus according to a preferred embodiment of the present invention.

FIG. 21 is a timing chart diagram showing the flow at the time of initial setting position detection in a content display apparatus according to a preferred embodiment of the present invention.

FIG. 22 is a timing chart diagram showing the flow at the time of contents changing, position changing, and enlarging/reducing operations in a content display apparatus according to a preferred embodiment of the present invention.

### DESCRIPTION OF THE PREFERRED EMBODIMENTS

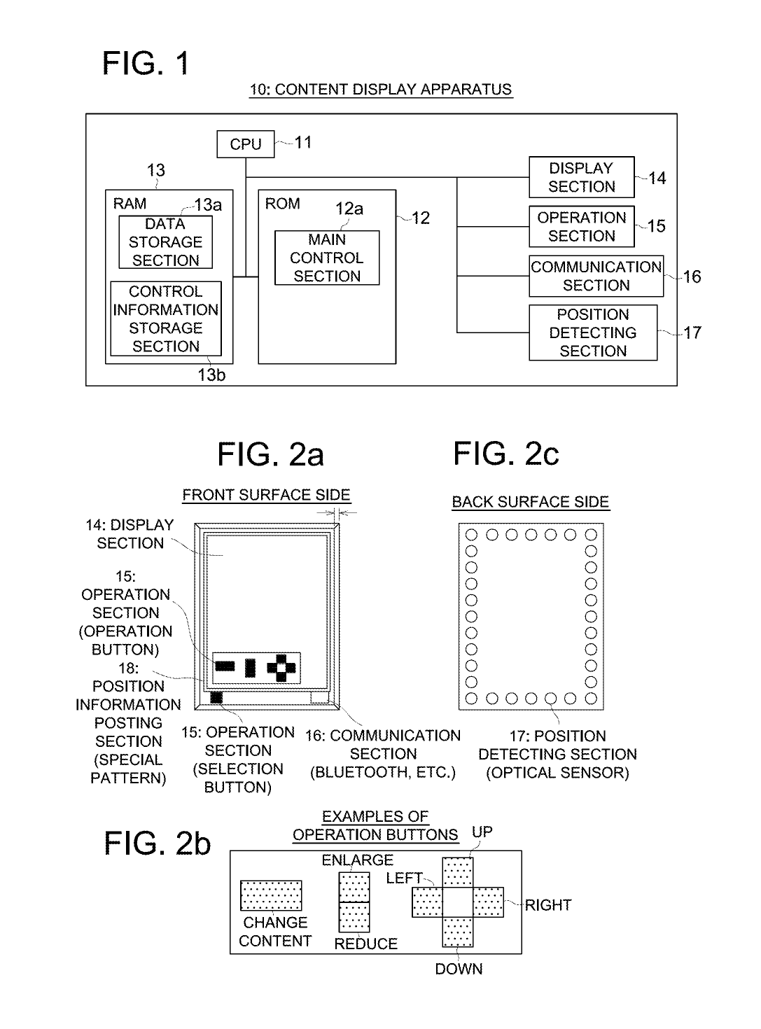

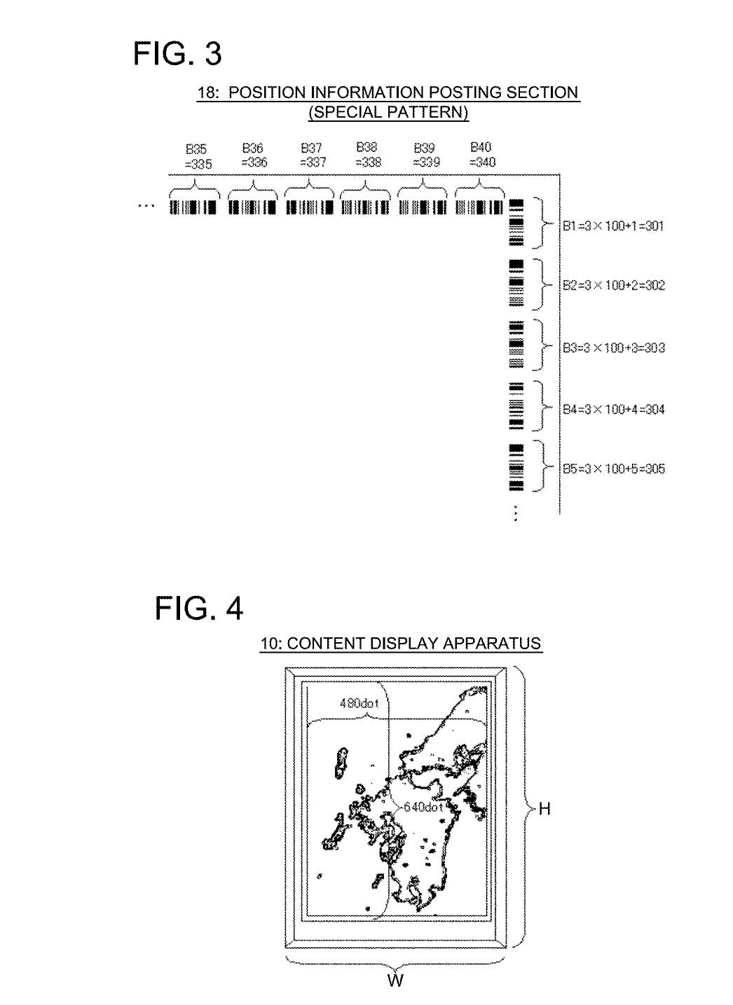

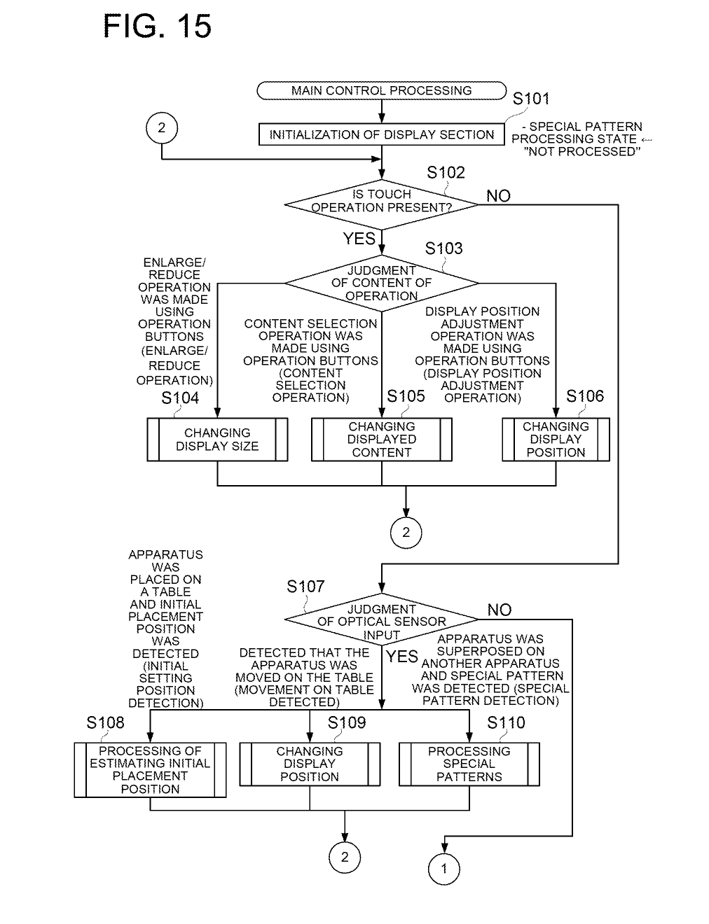

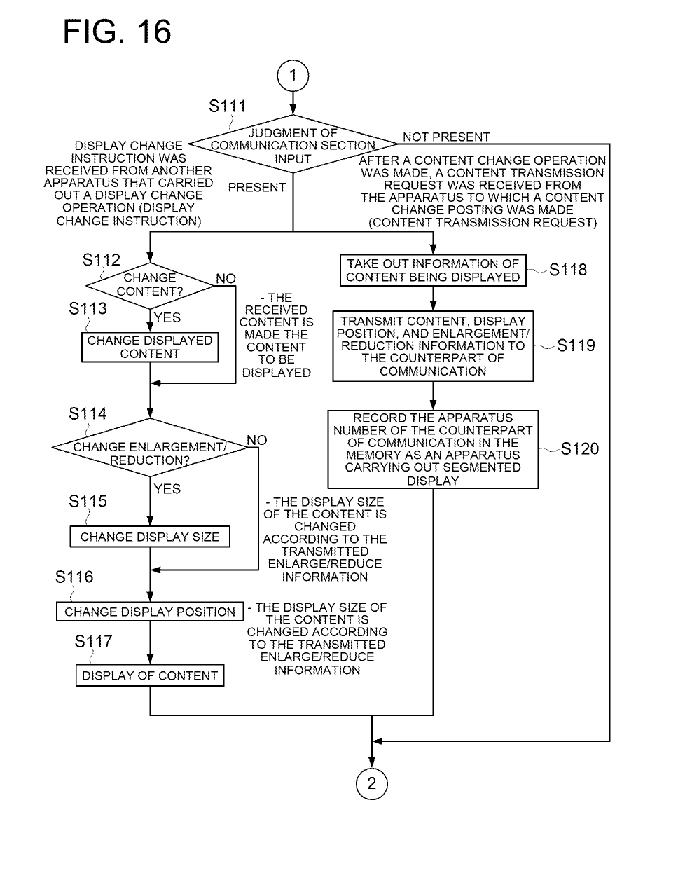

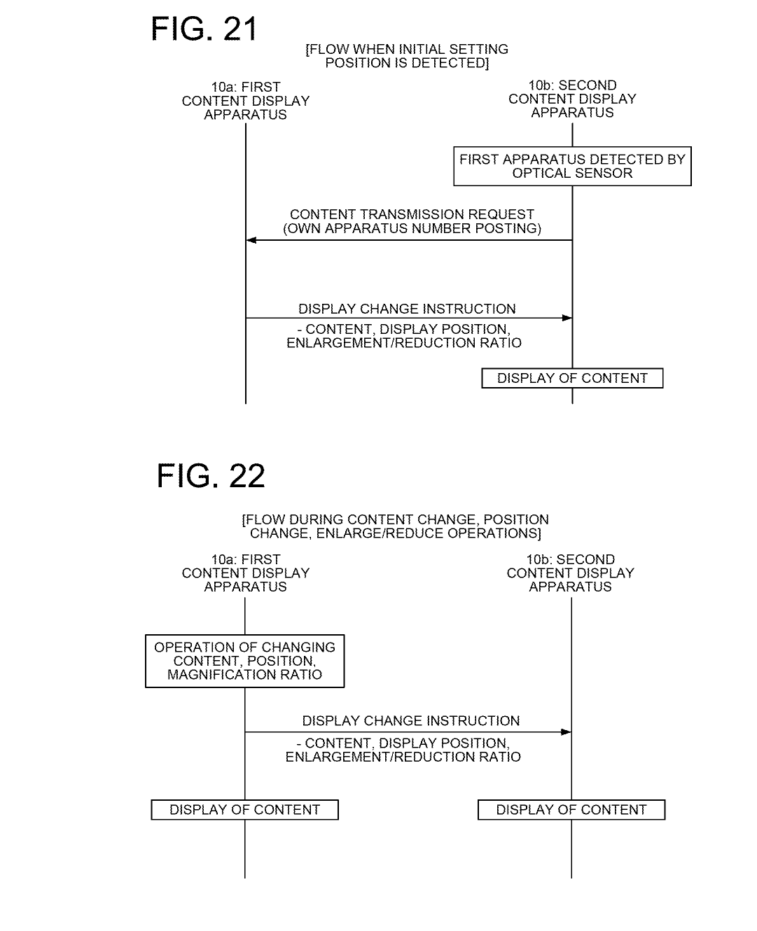

In order to explain in more detail a preferred embodiment of the present invention described above, a content display apparatus according to one preferred embodiment of the present invention is explained here referring to FIGS. 1 to 22. FIG. 1 is a block diagram showing the configuration of a content display apparatus according to the present preferred embodiment. FIG. 2 is a plan view diagram showing an example of the configuration of the front and back surfaces and the configuration of operation buttons of a content display apparatus according to a preferred embodiment of the present invention, and FIG. 3 is a plan view diagram showing an example of the configuration of a position information posting section placed in the peripheral edge part of the surface of a content display apparatus. FIGS. 4 to 14 are plan view diagrams showing examples of a display using content display apparatuses according to a preferred embodiment of the present invention. FIGS. 15 to 20 are flow charts showing the procedure of displaying a content using content display apparatuses according to the present preferred embodiment, while FIG. 21 and FIG. 22 are timing chart diagrams showing the processing among a plurality of content display apparatuses.

A content display apparatus 10 according to the present preferred embodiment is a movable thin type (flat plate shaped) apparatus, and as is shown in FIG. 1, is configured to have a CPU (Central Processing Unit) 11, memories such as a ROM (Read Only Memory) 12 or a RAM (Random Access Memory) 13, a display section 14, an operation section 15, a communication section 16, a position detecting section 17, etc.

The CPU 11 controls the operations of the different sections.

The ROM 12 stores various types of programs such as programs functioning as a main control section 12a, and these programs are executed by the CPU 11. The main control section 12a is provided with the function of displaying the images of the contents in the display section 14, and when the position detecting section 17 detects movements on the table or a position information posting section of another content display apparatus (details are described later), detects the relative position of the own apparatus, and carries out control so that the image of the contents displayed in the display section 14 is shifted according to the relative position of the own apparatus. Further, the control by this main control section 12a can also be executed as a program (contents display control program), or can also be executed as hardware.

The RAM 13 is a section that stores various types of data, and is provided with a data storage section 13a, a control information storage section 13b, etc. The data storage section 13a stores the image data of each page, etc., of the acquired contents. The control information storage section 13b stores the settings information for controlling the operations of the content display apparatus 10 or the unique apparatus identification information for identifying the own apparatus from other content display apparatuses, etc.

The display section 14 is made of a display device such as a liquid crystal display (LCD) or an organic EL (Electroluminescence) device, etc. and displays images of the contents.

The operation section 15 is a pressure sensitive type touch panel above the display section 14 and has grid shaped transparent electrodes placed in it, and detects by voltage values the XY coordinates of the pressure point that has been pressed by a finger or a touch pen, etc., and outputs to the CPU 11 the detected position signal as an operation signal.

The communication section 16 is configured from a wireless communication section such as Bluetooth (Registered trademark) or a wireless LAN (Local Area Network), and carries out data communication with other content display apparatuses, servers, etc. When this content display apparatus 10 is being used along independently, if the contents can be stored, it is possible to eliminate the communication section 16.

The position detecting section 17 is configured from a plurality of optical sensors that sense the direction and distance of relative movement from the image pattern on the ground plane such as those provided in optical mice, etc., and detects movement on a table or a position information posting section of other content display apparatuses, and detects the position of the own apparatus based on the information obtained from the image pattern on the ground plane or from the position information obtained from a position information posting section. When this content display apparatus 10 is being used independently, since it is not necessary to detect the position information posting section of other content display apparatuses, it is also possible to configure the position detecting section 17 using only one optical sensor, and for example, it is possible to configure the position detecting section 17 using an acceleration sensor, and to detect the position of the own apparatus based on the direction of movement and the amount of movement from the still position.

Further, FIG. 1 shows the basic configuration of a content display apparatus 10 according to the present preferred embodiment, and for example, can also have an HDD (Hard Disk Drive) for storing contents. In addition, a content display apparatus 10 according to the present preferred embodiment can also be configured as an apparatus for displaying the image of contents (for example, an electronic paper, electronic book, or electronic diary), or can also be one that is an apparatus provided with other functions (for example, mobile telephone or a PDA (Personal Digital Assistant)) which has been made to have functions of the above main control section 12a.

Next, the concrete configuration of a content display apparatus 10 according to the present preferred embodiment is explained. FIG. 2 is an example of the external view configuration of a content display apparatus 10 according to the present preferred embodiment.

As is shown in FIG. 2a, on the surface (front surface) of a content display apparatus 10, there are the display section 14 and the operation section 15 that carry out display of the image of the content and touch operations, and in their peripheral edge parts (can be inside the display section 14, or can be outside the display section 14) is provided a position information posting section 18 (this is not mandatory when the content display apparatus 10 is made to be operated alone independently) for posting the position of the own apparatus to other content display apparatuses 10. Further, a communication section 16 is provided at any position (preferably outside the display section 14) on the front surface (or the back surface).

The above position information posting section 18, is constituted from specific patterns (hereinafter referred to as special patterns) such as bar codes, etc., that can be read out by the position detecting section 17, and in each of the special patterns are written the position information such as the coordinates of the special patterns, etc. and the apparatus information that identify the own apparatus. Further, these special patterns can also be printed outside the display section 14, or can be displayed as a part of the image inside the display section 14. In addition, it is sufficient if the position information posting section 18 has a configuration that is capable of communicating the above position information and apparatus information to the position detecting section 17 of other content display apparatuses, and does not necessarily need to be restricted to special patterns such as bar codes, etc., and, for example, it is also possible to use fine patterns, multicolor inks or inks that cannot be seen by the human eye, or some member that emits information at a particular wavelength.

Further, as is shown in FIG. 2b, in the operation section 15, a plurality of operation buttons have been provided, and buttons for changing the contents, buttons for instructing the enlargement or reduction of the image display of the contents, buttons for adjusting the display position (up, down, left, and right buttons), etc. are arranged. It is also possible to display these operation buttons dynamically in the display section 14 depending on the state, or they can be placed in a fixed manner outside the display section 14. Here, a selection button is provided as a fixed button, and the operation buttons are displayed in the display section 14 when this button is pressed once, and when this button is pressed again, the display of the operation buttons disappears. Further, when the content changing button is pressed, a menu for selecting the contents is displayed, and the displayed content is selected according to the menu. When the enlarge/reduce button is pressed, correspondingly, the enlargement ratio or the reduction ratio of the image of the content currently being displayed is increased or decreased by a fixed amount. For example, if the enlarge button is pressed once, the magnification ratio is made double the current value, and when the reduce button is pressed once, the magnification ratio is made half the current value. The display position adjusting buttons (the buttons up, down, left, and right) respectively move the displayed image of the content up, down, left, or right. The amount of movement can be a fixed number of pixels, or the number of pixels by which to move can be varied according to the current enlargement or reduction ratio. The initial display position and the state of the enlargement or reduction ratio at the time of changing contents can be anything, for example, the display can also be made in the same size taking the top left of the contents as the reference point, or the enlargement or reduction ratio can be calculated so that the entire image of the content fits within the screen, and the center of the image is made to coincide with the center of the display section 14.

Further, in the peripheral edge part of the back side of the content display apparatus 10, the position detecting sections 17 such as optical sensors, etc., are arranged at fixed intervals. Further, the size, shape, placement, and number, etc. of the position detecting sections 17 are not restricted to those shown in the figure, and it is also possible to arrange them over the entire back surface.

Next, the concrete configuration of a position information posting section 18 (special patterns) is described here referring to FIG. 3.

Special patterns, for example, are constructed using an array of a plurality of image codes Code 1 to Code M (where M is the number of special patterns arranged for one apparatus) that have information that can be read out by a position detecting section 17 (optical sensor), and each image code is constructed in the form of a pattern that includes the arrangement code P-Code for that image code and the apparatus identification information D-Code.

Here, there are a total of 40 bar codes B1 to B40 with ten of them each being placed at each of the four edges of the content display apparatus 10, and the bar codes at the right edge in the figure are taken to be B1 to B10, the bar codes at the bottom edge are taken to be B11 to B20, the bar codes at the left edge are taken to be B21 to B30, and the bar codes at the top edge are taken to be B31 to B40. Each of these bar codes has information that is a sum of a value equal to that bar code number 1 to 40 and 100 times the value of the apparatus identification number N (here, N is taken to be equal to 3). In other words, the S^{th} image code Code S is calculated as S+N×100.

The operation of a content display apparatus 10 with the above configuration is described in the following.

To begin with, the processing when the image of a content is displayed using one content display apparatus 10 is explained referring to FIGS. 4 to 6.

When the content display apparatus is placed on a table and is moved on the table to the left, right, up, or down, while the image of the content being displayed in the display section 14 shifts in a direction opposite to the direction of movement of the content display apparatus 10, the amount of that shift is varied according to the enlargement or reduction ratio of that content being displayed.

For example, consider that a certain content is being displayed in the same size, and the content display apparatus 10 is moved on a table physically by a distance A to the right. At that time, if the display position of the content in the display section 14 of the content display apparatus 10 is shifted to the left by just B dots, assume that, as seen by the user, the physical display location of the content on the table does not change. At this time, A=N×B, where N is the physical length over which is being displayed the width of one dot (one pixel) of the content in the content display apparatus 10. In other words, when the content display apparatus 10 is moved to the right by a distance A, it is sufficient to shift the display position of the content to the left by B dots.

Further, when the content is being displayed with an enlargement/reduction ratio (scale) of X times, since the physical width of one dot of the content in the content display apparatus 10 becomes N×X, when the content display apparatus 10 is moved to the right by a distance A, it is sufficient to shift the display position of content by B′ dots to the left so that A=(N×X)×B′. Further, it is sufficient to obtain the amount of shift in a similar manner even when the content display apparatus 10 is moved to the left, up, down, or in an oblique direction.

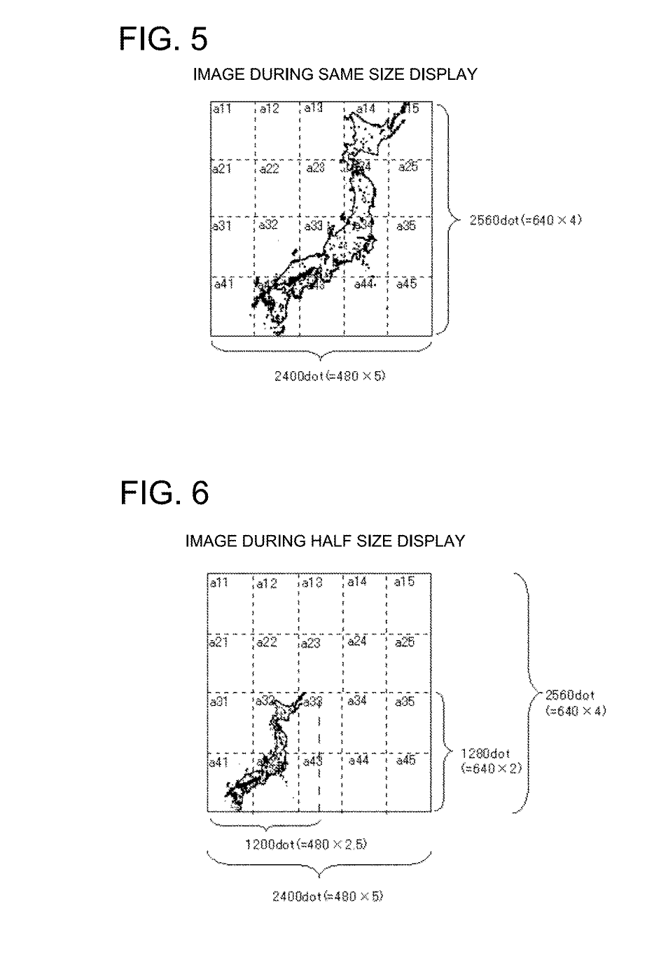

Explaining in concrete terms, as is shown in FIG. 4, consider that the content display apparatus 10 is of a size with a width W and height H, and that the resolution of the display section 14 is 480 horizontal dots and 640 vertical dots. Here, as is shown in FIG. 5, the image of the content (map of Japan) is divided into 5 segments horizontally and 4 segments vertically, and each area is designated as a11 to a45, and the Kyushu region (the region of a42) is being displayed in the same size. The overall size of the image of the content is 2400 dots horizontally (480×5) and 2560 dots vertically (640×4). Further, although there can be a difference equal to the boundary edge part between the size of the actual display section 14 and the size of the width W and height H, in the following, in order to make the explanations simpler, it is assumed that the size of the display section 14 is equal to the size of a width W and a height H. When there is a difference in these sizes, it is sufficient to carry out the calculations taking into consideration the difference in the following processings.

The content display apparatus 10 is placed on a table, and when the content display apparatus 10 is moved on the table, the direction and distance of that movement is being detected by the position detecting section 17 on the back side of the apparatus. In the condition in which the region a42 corresponding to the Kyushu region is being displayed, when the content display apparatus 10 is moved on the table to the right by a distance W, since the image of the content being displayed is shifted by 480 dots, it means that exactly the region a43 will be displayed. Further, when the apparatus is moved by only W×0.1, the content shifted by 48 dots will be displayed. The display is made by making similar calculations even when the movement is made to the left, up, or down.

Next, when the content is not being displayed with the same size, but is being displayed as is shown in FIG. 6 with a reduction ratio of half, the size of the entire image of the content to be displayed becomes 1200 horizontal dots and 1280 vertical dots. In the condition in which the region a41 corresponding to the Kyushu and Chugoku regions is being displayed at present, if the content display apparatus 10 is moved on the table by W to the right, the content being displayed is shifted by 240 dots. In terms of the content before reduction, this is equivalent to being shifted by 480 dots. When moved by just W×0.1, the content is shifted by 24 dots, or by 48 dots if the content before reduction will be displayed.

In this manner, in the condition in which the image of the content is being displayed as an image with a scale factor of X times, when the content display apparatus 10 is moved on the table by a fixed distance, it is sufficient to display the content shifted by X times the amount of shift that is made during the same size display multiplied by the scale factor of X times.

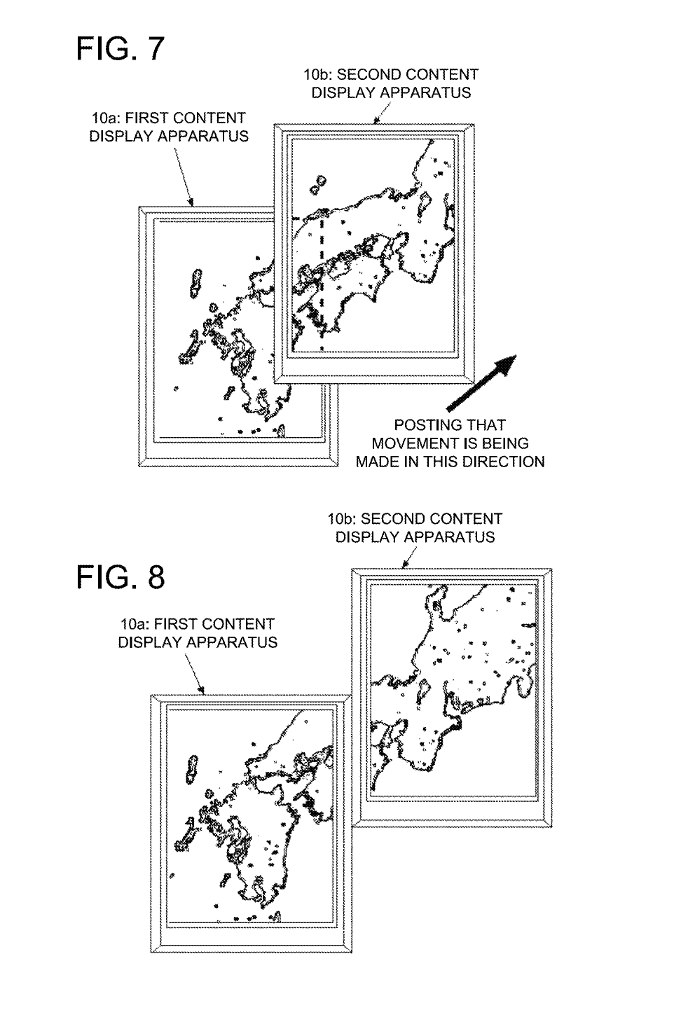

Next, the processing when the image of a content is displayed using two content display apparatuses 10 is explained here referring to FIGS. 7 to 14, FIG. 21, and FIG. 22.

Processing when a second content display apparatus 10b is superposed:

FIG. 7 shows the condition in which a second content display apparatus 10b is placed overlapping a first content display apparatus 10a.

When one or a plurality of position detecting sections 17 (optical sensors) of the second content display apparatus 10b detect one or a plurality of the position information posting sections 18 (special patterns) of the first content display apparatus 10a, from the combination of at least one position detecting section 17 and position information posting section 18, the position of that superposing and the first content display apparatus 10a that is displaying that special pattern are judged.

The second content display apparatus 10b carries out communication via Bluetooth (Registered trademark) with the judged first content display apparatus 10a, obtains the image of the contents being currently displayed in the first contents display apparatus 10a, and displays the superposed image in the display section 14 (the image with the reference point of display changed based on the position relationship between the position information posting section 18 of the first content display apparatus 10a and the position detecting section 17 of the second content display apparatus 10b). In other words, as is shown in FIG. 21, the second content display apparatus 10b transmits a content transmission request (posts its own apparatus number) to the first content display apparatus 10a, as a reply to that, the first content display apparatus 10a transmits as a message to the second content display apparatus 10b the image of the content being displayed and the information of its display position and the enlargement or reduction ratio, and also records the own apparatus number posted from the second content display apparatus 10b in the memory of the first content display apparatus 10a as the information of the apparatus makes a divided display. Further, in case the content is stored in a server, etc., that has been connected to a communication network, the second content display apparatus 10b can also obtain the image of the content from that server, etc.

Further, as is shown in FIG. 22, when the operations of changing, enlarging, or reducing the content, or of changing the display position have been made, the fact that such an operation was made is posted to all the content display apparatuses 10 (here, the second content display apparatus 10b) that are making the segmented display and that have been stored in the memory. The information of the content display apparatuses that are making the segmented display of content can also be included in the display change instruction message, or can also be posted as a separate message to the other content display apparatuses 10 that are making the segmented display. Further, even when the operations of changing, enlarging, or reducing the content, or of changing the display position have been made in a content display apparatus 10 making the segmented display other than the first content display apparatus 10a, they can be shared with other content display apparatuses 10 making the segmented display.

After that, when the position detecting section 17 (optical sensor) of the second content display apparatus 10b detects the movement of a special pattern, the direction of that movement is calculated, and where it is being placed on the table is estimated assuming that it will be a position adjacent to first content display apparatus 10a.

Processing when it is detected that a second content display apparatus 10b is placed on the table:

FIG. 8 shows the state at the instant when it is detected that a second content display apparatus 10b was placed on the table.

Since the first content display apparatus 10a has a certain thickness, just before a second content displaying apparatus 10b is placed on the table, the position detecting section 17 (optical sensor) temporarily goes into the state of not being able to carry out image reading, and as soon as the apparatus is placed on the table, it again goes into the state in which it can carry out image reading. With this event of being able to carry out image reading again, it detects that a second content display apparatus has been placed on the table (that the state is one in which the second content display apparatus 10b is no longer superposing on the first content displaying apparatus 10a). In the case of an optical sensor using LEDs, the light emitted from an oblique angle and reflected from the ground plane towards the LED is read out by an optical sensor that is vertically above the ground plane, and the direction of movement is being detected by the changes in the image of that ground plane. In this manner, since it is possible to form an image and carry out detection only by obtaining sufficient reflected light at the point of intersection between the illuminating angle from an LED at an oblique angle and the image reception direction of the optical sensor in the vertical direction, in the condition in which the distance between the ground plane and the sensor is separated substantially, sufficient reflected light cannot be obtained and it is a state in which it is not possible to read into the image.

When it is detected that the second content display apparatus 10b has been placed on the table, the position estimated in the processing in the state of superposing the second content display apparatus 10b is established as the initial placement position of the second content display apparatus 10b.

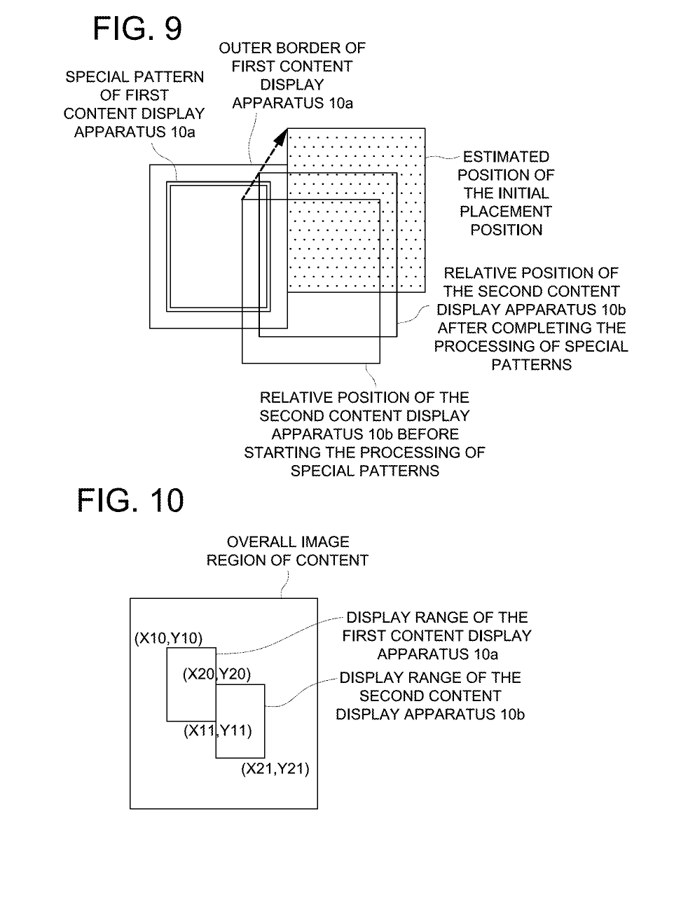

FIG. 9 shows the form of estimating the initial setting position.

When one or a plurality of position detecting sections 17 (optical sensors) of the second content displaying apparatus 10b detect for the first time one or a plurality of the position information posting sections 18 (special patterns) of the first content display apparatus 10a, from the position of the optical sensors that read out the image code of the special patterns at that time, the relative position of the second content display apparatus 10b, that is, the position of the second content display apparatus 10b relative to the first content display apparatus 10a is calculated and recorded. This is called the relative position of the second content display apparatus 10b at the time of starting the processing of special patterns.

Next, again, when a special pattern is detected, the relative position calculated at that time is recorded, and this is called the relative position of the second content display apparatus 10b at the time of ending the processing of special patterns. When a special pattern is detected again, this is overwritten as the relative position of the second content display apparatus 10b at the time of ending the processing of special patterns. After these, when it is detected that the second content display apparatus 10b has been placed on the table, the shortest point of contact between the second content display apparatus 10b and the first content display apparatus 10a on the line from the relative position of the second content display apparatus 10b at the time of starting said processing of special patterns to the relative position of the second content display apparatus 10b at the time of ending the processing of special patterns is obtained, and this is taken as the initial setting position.

FIG. 10 shows the content display range.

Consider that the first content display apparatus 10a is displaying a content in the same size, and is displaying in the range from the position of X10 dots to the right and Y10 dots downwards from taking the top left of the content as the reference point to the position of X11 dots to the right and Y11 dots downwards. At this time, if it is considered that the initial setting position of the second content display apparatus 10b has been detected along the coordinates X11 of the right side of the first content display apparatus 10a, the range that the second content display apparatus 10b has to display in the initial condition is from the position at X20 dots to the right and Y20 dots downwards from the reference point at top left of the content to the position at X21 dots to the right and Y21 dots downwards, and these are obtained using the following equations, respectively.

X20=X11

Y20=Coordinates in the vertical direction at the time of detecting the initial setting position

X21=X20+(X11−X10)

Y21=Y20+(Y11−Y10)

Further, in case there is a gap between the display range of the first content display apparatus 10a and the display range of the second content display apparatus 10b, taking the number of dots B1 to correspond to that gap, it is possible to correct using a form such as X20=X11+B1.

When the display of the content is not of the same size, while the width and height of the content displayed in one content display apparatus 10, that is, the magnitudes of (X11−X10) and (Y11−Y10), will have values different from those at the time of the same size display, but they can be obtained by calculating in the same manner as above.

Processing when the second content display apparatus 10b is moved on the table:

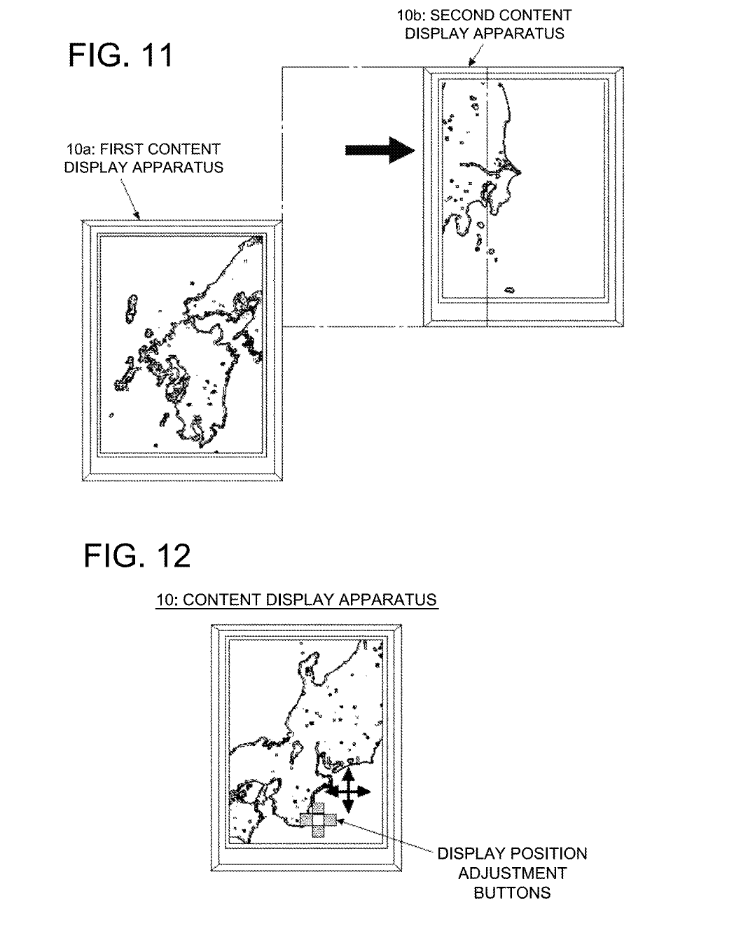

FIG. 11 shows the situation when the second content display apparatus 10b is moved on the table.

After the position of the second content display apparatus 10b has been established as the initial placement position, when movement on the table is detected by the position detecting sections 17 (optical sensors) of the second content display apparatus 10b, the content of display in that second content display apparatus 10b is shifted to match that movement. The amount of shift, as has been explained earlier, is similar to that when the image of the content is displayed using only one content display apparatus 10, and can be carried out according to the enlargement or reduction ratio of the content.

For example, in the condition in which the physical position of the second content display apparatus 10b has moved and the content to be displayed is shifted, if the amount of that shift is taken to be DX1 dots towards the right and DY1 dots downwards, the range of content to be displayed by the second content display apparatus 10b becomes as follows.

X20=X11+DX1

Y20=Coordinates in the vertical direction at the time of detecting the initial setting position+DY1

X21=X20+(X11−X10)+DX1

Y21=Y20+(Y11−Y10)+DY1

Further, depending on the position of the second content display apparatus 10b, the values of DX1 and DY1 can take on negative values.

Synthesizing third and subsequent content display apparatuses:

As the segmented display of content was made by superposing the second content display apparatus 10b over the first content display apparatus 10a, it is possible to add any number of apparatuses from the third and subsequent content display apparatuses to the segmented display. At that time, the lower apparatus of superposition can be any apparatus that is already carrying out the segmented display of contents. For example, when a third content display apparatus is superposed on the second content display apparatus 10b, it is sufficient to shift the content of display at the initial placement position of the third content display apparatus based on the state of shifting the current content of display of the second content display apparatus 10b.

Adjustment of the content of display:

When a shift occurs in the position of content display based on the initial setting position, the display position is corrected by carrying out touch operations to the left, right, up, or down in the screen on the apparatus. It is sufficient to detect the direction of shift and the amount of shift using the difference between the starting position of touching the screen and the ending position. In this case, as is shown in FIG. 12, it is also possible to display on the screen the buttons for carrying out correction of the display position (display position adjustment buttons), and to shift in any direction by any amount by pressing these buttons.

Processing when enlarging/reducing operations are made during display in a plurality of apparatuses:

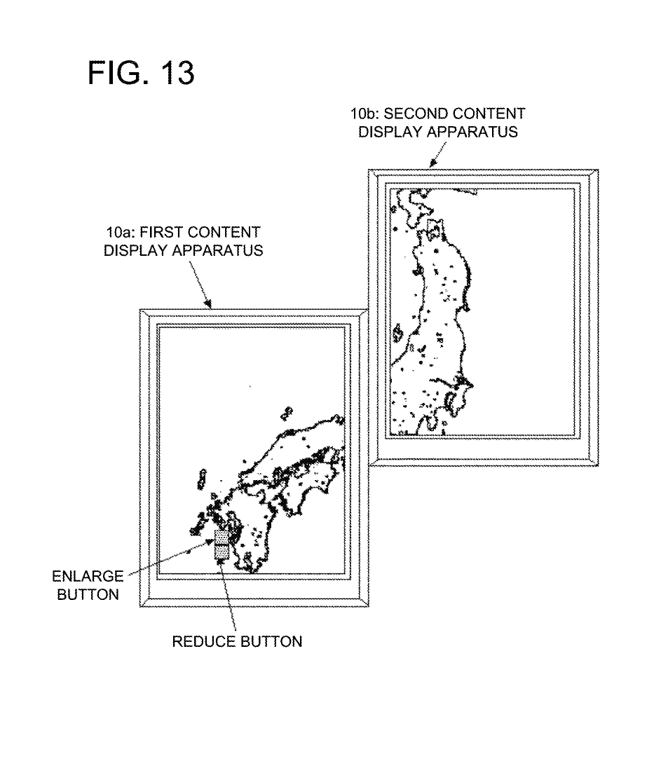

As is shown in FIG. 13, in the state in which a single content is being displayed in a plurality of content display apparatuses, when an enlarging or reducing operation is made in any apparatus, in all the apparatuses displaying the same content, it is possible to carry out not only enlarging/reducing operations respectively with the same ratio, but also to carry out corresponding shifting of the display position. The reference point for shifting the display position can be the apparatus in which the enlarging/reducing operation was made, or can be the first content display apparatus 10a which displayed the content first.

Processing when the content is changed when the display is being made in a plurality of apparatuses:

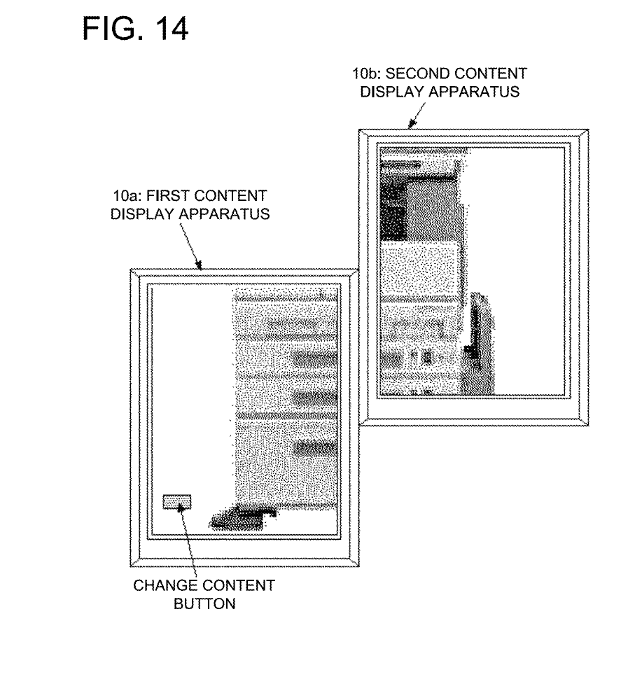

In the state in which a content is being displayed in a plurality of contents, when an operation of displaying a different content is made in any apparatus, as is shown in FIG. 14, it is possible not only to display the new content in that apparatus, but also, to display the new content respectively with the same enlargement/reduction ratio in all the apparatuses in which the same content was being displayed at a time just before that operation was made, and also, it is possible to detect the relative position corresponding to the new content, from the relative position before that operation, and to shift the respective display positions.

In the above, although explanations were given about the individual processings, when displaying a content using a plurality of content display apparatuses 10, the sequence of operations of the control section of the content display apparatus 10 that becomes the reference (the main control section) is explained here referring to the flow charts of FIGS. 15 to 20.

The control section of the content display apparatus 10 (the main control section 21a) carries out the initialization of the display section 14 (S101), and monitors the touch operation in the operation section (S102). When a touch operation is present, it judges the content of the operation (S103), and executes processing according to the content of the operation.

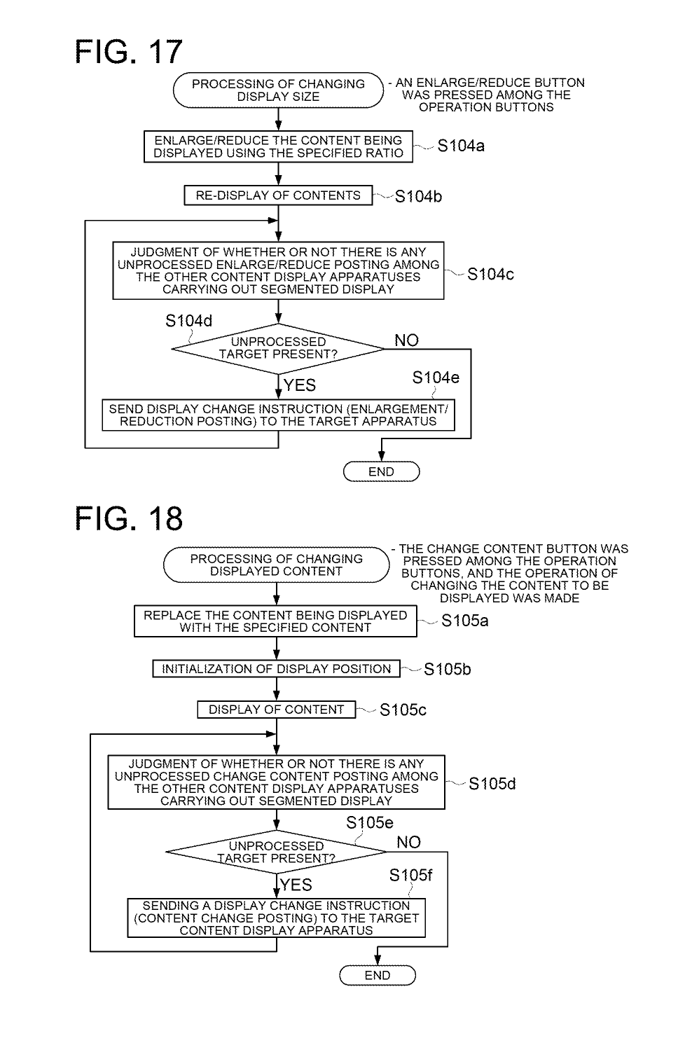

For example, when an enlarging or reducing operation is made using the operation buttons, it executes the processing of changing the display size (S104). In concrete terms, as is shown in FIG. 17, the content being displayed is enlarged or reduced according to the specified ratio (S104a), the content is displayed again (S104b), and a judgment is made as to whether or not there is any unprocessed enlarge/reduce posting among the other content display apparatuses 10 carrying out segmented display (S104c). If there is any unprocessed enlarge/reduce posting (Yes in S104d), using the communication section 16, a display change instruction (enlarge/reduce posting) is given to the target content display apparatus 10 (S104e), and the processing from S104c to S104e is repeated until there is no apparatus with an unprocessed enlarge/reduce posting.

Further, when a content selection operation is made using the operation buttons, the processing of changing the displayed content is carried out (S105). In concrete terms, as is shown in FIG. 18, the content being displayed is replaced with the specified content (S105a), after carrying out initialization of the display position (S105b), the content is displayed (S105c). Next, a judgment is made as to whether or not there is any unprocessed content change posting among the other content display apparatuses 10 carrying out segmented display (S105d). If there is any unprocessed content change posting (Yes in S105e), using the communication section 16, a display change instruction (content change posting) is sent to the target content display apparatus 10 (S105f), and the processing from S105d to S105f is repeated until there is no apparatus with an unprocessed content change posting.

Further, when a display position change operation is made using the operation buttons, the processing of changing the display position is carried out (S106). In concrete terms, the content being displayed is shifted by the specified number of dots, and a judgment is made as to whether or not there is any unprocessed display position change posting among the other content display apparatuses 10 carrying out segmented display. If there is any unprocessed content change posting, using the communication section 16, a display change instruction (display position change posting) is given to the target content display apparatus 10, and this processing is repeated until there is no apparatus with an unprocessed display position change posting.

Next, after executing each of the changing processings, the operation returns to Step S102.

When there is no tough operation in Step S102, an input judgment is made of the position detecting section 17 (optical sensor) (S107), and when the optical sensors detect any information, processing is carried out according to the content of the detection.

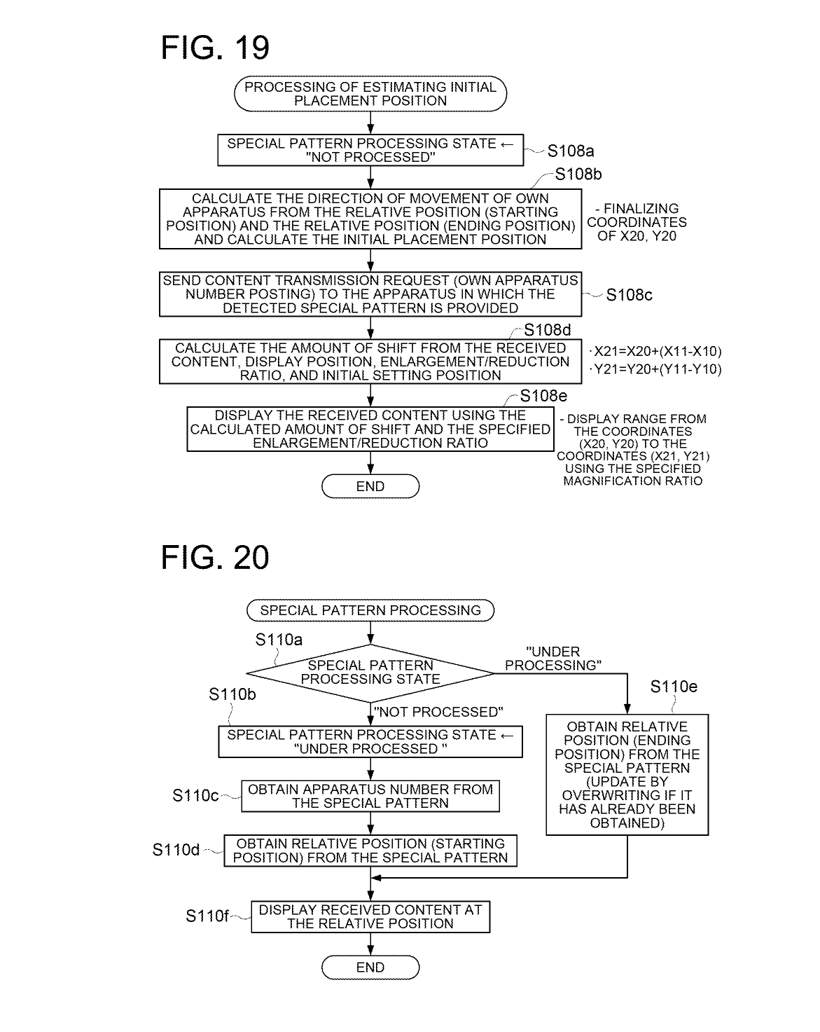

For example, when the content display apparatus 10 is placed on a table and the initial placement position is detected, the initial placement position estimation processing is carried out (S108). In concrete terms, as is shown in FIG. 19, the processing state of the position information posting section 18 (special patterns) is set to the unprocessed state (S108a), from the starting position and the ending position, the direction of its own movement is calculated, and the initial placement position is calculated (S108b). Next, the apparatus number is obtained of the content display apparatus in which is provided the special pattern whose starting position and ending position were detected, using the communication section 16, a content transmission request (own apparatus number posting) is transmitted to that content display apparatus (S108c). Then, from the content, display position, enlargement/reduction information, and the initial setting position obtained from the above content display apparatus, the display shift is calculated (S108d), and the received content is displayed using the calculated shift amount and the enlargement/reduction ratio (S108e).

Further, when it is detected that the content display apparatus 10 is moved on the table, based on the direction and amount of that movement, the processing of changing the display position is carried out using the method described earlier (S109).

Further, when a content display apparatus 10 is superposed on another content display apparatus and special patterns are detected, the processing of special patterns is executed (S110). In concrete terms, as is shown in FIG. 20, the status of processing the special pattern is judged (S110a), and if it is “not processed”, the status of processing the special pattern is set to “under processing” (S110b), the apparatus number is obtained from the special pattern (S110c), and the relative position (the starting position) with respect to that apparatus is obtained (S110d). On the other hand, if the status of processing of the special pattern is “under processing”, from the special pattern, the relative position with respect to the above apparatus (the ending position) is obtained (S110e). At that time, if the relative position (the ending position) has already been obtained, it will be overwritten. After that, the content is displayed at the obtained relative position (S110f).

Next, after carrying out each of the changing processings, the processing returns to Step S102.

When the optical sensors do not detect information in Step S107, input judgment of the communication section 16 is carried out (S111), and when there is no input from the communication section 16, the operation returns to Step S102.

When the communication section 16 receives a display change instruction from another apparatus in which a display change operation has been made, a judgment is made as to whether or not there is a content change (S112), and the displayed content is changed if there is a content change (S113). Next, a judgment is made as to whether or not there is an enlargement/reduction change (S114), and the display size is changed if there is an enlargement/reduction change (S115). Then, the display position is changed (S116), the content is displayed (S117), and the operation returns to Step S102.

Further, after carrying out a content change operation, when the communication section 16 receives a content transmission request from the apparatus to which the content change posting had been sent, the information of the content being displayed is taken out (S118), and transmits the content, display position, and enlargement/reduction information to the counterpart of communication (S119). After that, the apparatus number of the counterpart of communication is recorded in the memory as an apparatus carrying out segmented display (S120), and the operation returns to Step S102.

By carrying out processings in this manner, using the content display apparatus 10, it is possible to display a large image of a content in a natural manner similar to that of a paper medium.

However, although in the present preferred embodiment an example was described displaying a single content segmenting it among a plurality of apparatuses, the present invention shall not be construed to be limited by the above preferred embodiment, and it is also possible to display different contents or different pages in each of the apparatuses. In that case, in accordance with the distance between apparatuses on the table, it becomes possible to display different pages, and by merely moving an apparatus, it is possible to change the page of the contents to be displayed instinctively. For example, in the condition in which the N^{th} page is being displayed in a first content display apparatus 10a, it is possible to carry out control such that, if a second content display apparatus 10b is moved in a direction away from the first content display apparatus 10a by one tenth of the width of the apparatus, the page number of the page displayed in the second content display apparatus 10b is increased by 1 page, or the page number is decreased by 1 page if that apparatus is moved in a direction closer to the first content display apparatus 10a, etc.

According to the content display apparatuses of the preferred embodiments, they are possible to display the image of contents according to the position of the apparatuses.

The reason for this is that, when the content display apparatus is being used independently, on the reverse side of the content display apparatus, a position detecting section is provided that detects movements on the table and detects the relative position of own apparatus, and the control section of the content display apparatus, when the position detecting section detects movement on the table, carries out control so as to shift the image of the contents being displayed in the display section according to the position after movement.

Further, when a plurality of content display apparatuses is being used, the reason for this is that, on the peripheral edge parts of the surfaces of each of the content display apparatuses, not only are position information posting sections such as bar codes, etc., indicating their positions provided, but also, on the back surfaces, are provided position detecting sections that not only obtain the position information and apparatus information from the position information posting section but also detect the movement on the table thereby detecting the relative position of the own apparatus, and the control section of a prescribed content display apparatus carries out control, when the position detecting section obtains the position information from the position information posting section of another content display apparatus, so that it shifts, in the display section, the image that is being displayed in the other content display apparatus according to the relative position with respect to that other content display apparatus, and displays it in the display section of the own apparatus. In addition, when the position deteting section detects either another content display apparatus or movement on the table, it is possible to carry out control so that the image of the contents being displayed in the display section is shifted according to the position after movement.

Here, in the preferred embodiments, the relative position of the content display apparatus is detected automatically, and the image of the contents is made to be displayed in the content display apparatus according to that position.

In concrete terms, when a single content display apparatus is being used independently, on the back of the content display apparatus, is provided a position detecting section such as an optical sensor, etc., that detects the direction of movement and distance of movement of that content display apparatus by detecting the movement on the table, and the control section of the content display apparatus, when the position detecting section detects movement, carries out control so that the image of the contents being displayed in the content display apparatus is shifted by a distance according to the above distance of movement in a direction opposite to the above direction of movement.

Further, when using a plurality of content display apparatuses, the plurality of content display apparatuses are taken as a system that displays a large virtual screen, and on the edge parts of the surfaces of each of the content display apparatuses, position information posting parts such as bar codes, etc., stored as own position information and own apparatus information are provided, and also, on the backs of the content display apparatuses, are provided position detecting sections such as optical sensors, etc., that not only obtain from the position information posting part the own position information and own apparatus information but also detect movements on the table and detect the relative position of the own apparatus, and the control section of the prescribed content display apparatus, when that prescribed content display apparatus is laid over other content display apparatuses, detects the relative position of the own apparatus based on the positions of the position detecting section and the position information posting sections of other content display apparatuses, and carries out control so as to shift the images of the contents being displayed in those other content display apparatuses based on the relative positions with respect to those other content display apparatuses, and to display in the display section of the own apparatus.

Further, when the prescribed content display apparatus is moved, the relative position of the own apparatus after moving is detected based on the change in the position information obtained from the position information posting sections of other content display apparatuses or on the amount of movement on the table, and control is carried out so as to shift the contents being displayed in the prescribed content display apparatus according to the position after movement.

By having a construction such as this, it is possible to display a large image of contents similar to a paper medium.

What is claimed is:

1. A movable content display apparatus with a display section displaying contents comprising;
a position detecting section which is arranged on the surface on the opposite side of the display section and detecting image patterns; and
a control section shifting a display position of the image of the contents being displayed in the display section by a distance according to the movement distance and in a direction opposite to the movement direction, when the position detecting section detects from the changes in the image pattern that the own apparatus has moved on a table by a certain movement distance in a certain movement direction.

2. The content display apparatus of claim 2,
wherein the control section shifts a display position of the image of the contents being displayed in the display section by a distance according to the movement distance which is multiplied a certain magnification by movement distance and in a direction opposite to the movement direction, when the image of the contents being displayed with certain magnification.

3. A plurality of movable content display apparatuses with display sections displaying contents and a communication sections wherein each of the content display apparatuses comprising;
a plurality of image patterns storing own apparatus position information and apparatus information identifying own apparatus wherein the image patterns are on the peripheral edge parts on the same surface of the display section;
at least one position detecting section arranged on the surface on the opposite side of the display section and detecting image patterns;
a control section of the second content display apparatus detecting the relative position of the own apparatus relative to the first content display apparatus based on the position of the first image pattern of the first content display apparatus and the position of the position detecting section of the second content display apparatus, obtaining the contents and display position of the image being displayed in the display section of the first content display apparatus identified by the apparatus information stored in the first image pattern by using the communication section,
shifting the display position of the image of the contents based on the relative position, and displaying in the display section of own apparatus, when the position detecting section detects a first image pattern of the first content display apparatus, in case of a second content display apparatus is laid over a first content display apparatus.

4. The content display apparatus of claim 3,
wherein the control section of the second content display apparatus detects the direction of movement and the distance of movement of own apparatus relative to the first content display apparatus based on the changes in the positions of the first image pattern and the second image pattern; and then
shifts the image of the contents being displayed in the display section of own apparatus by a distance according to the distance of movement in a direction opposite to the direction of movement,
when the position detecting section detects a second image pattern of the first content display apparatus.

5. The content display apparatus of claim 4,
wherein the control section of the second content display apparatus detects the initial setting position in which the first content display apparatus and the second content display apparatus do not overlap each other based on the changes in the positions of the first image pattern and the second image pattern; then,
the position detecting section detects from the changes in the image pattern that the own apparatus has moved on the table by a certain distance of movement in a certain direction of movement; and then,
the control section of the second content display apparatus shifts the image of the contents being displayed at the initial setting position in said display section of own apparatus by a distance according to the distance of movement in a direction opposite to the direction of movement.

6. The content display apparatus of claim 4,
wherein the control section of the second content display apparatus shifts a display position of the image of the contents being displayed in the display section of own apparatus by a distance according to the movement distance which is multiplied a certain magnification by movement distance and in a direction opposite to the movement direction, when the image of the contents being displayed with certain magnification.

7. The content display apparatus of claim 3,
when the image of the contents being displayed in the first content display apparatus is changed,
wherein the control section of the second content display apparatus obtains the changed contents and display position of the image being displayed in the display section of the first content display apparatus; then
sifts the image of the contents of the contents based on the relative position of the own apparatus relative to the first content display apparatus and the display position; and then,
displays the image of the contents in the display section of own apparatus.

8. The content display apparatus of claim 3,
when the display position of the image being displayed in the display section of the first content display apparatus is changed,
wherein the control section of the second content display apparatus obtains the changed display position from the first content display apparatus; then
sifts the image of the contents based on the relative position of the own apparatus relative to the first content display apparatus and the display position.

9. The content display apparatus of claim 3,
when the magnification of image of the contents being displayed in the display section of the first content display apparatus is changed,
wherein the control section of the second content display apparatus obtains the changed magnification from the first content display apparatus; then
changes the magnification of image of the contents display section of the own apparatus to the obtained magnification; and them
shifts the image of certain magnification based on the relative position of the own apparatus relative to the first content display apparatus and the certain magnification.
